(19) United States
(12) Patent Application Publication
(10) Pub. No.: US 2026/0104117 A1
(43) Pub. Date: Apr. 16, 2026

(54) RV Sewer Hose Support

(71) Applicant: Rodney Eugene Sturgis, Davison, MI (US)

(72) Inventor: Rodney Eugene Sturgis, Davison, MI (US)

(21) Appl. No.: 18/914,142

(22) Filed: Oct. 12, 2024

(51) Int. Cl. F16L 27/12; E03F 1/00; F16L 27/02

(52) U.S. Cl. CPC F16L 27/12; E03F 1/008; F16L 27/023

(57) ABSTRACT

A telescoping RV (Recreational Vehicle) sewer hose support to provide continuous rigid support, hose guidance and the proper drain angle for the RV sewage drainage. This support includes inner sliding tubes for varying connection lengths and flexible hose bend supports with pivots and swivels to accomplish almost every angle of attachment. When combined with an RV flexible sewer hose, the sewer hose support and hose will provide a fully captivated, all-in-one gravity drainage solution that can be easily setup or stowed away.

### 1. FIELD OF THE INVENTION

The invention pertains to a support for a recreational vehicle (RV) flexible sewer hose and predominantly pertains to a complete hose support that can be extended and retracted for variable distances to the waste disposal drain. The invention provides rotation and pivots at each end to match the angles of both RV flexible sewer hose connection points. The invention completely supports the flexible sewer hose at the bends, as well as the straits, from sagging and rolling, causing blockages.

### 2. BACKGROUND OF THE INVENTION

For most recreational vehicle owners, the most unpleasant, unwanted and at times gross, part of camping or RV living relates to the sewage equipment connection and handling. This can be a cumbersome, messy and frustrating occurrence, for what should be an enjoyable and pleasurable get-away or way of living. A large portion of RV owners do not look forward to this part of camping because previous products do not provide a one-piece solution or support the bend locations of the flexible sewer hose. This invention provides an all-in-one more sanitary solution, and cleans up the messy handling and disliked part of RV ownership.

### 3. DESCRIPTION OF THE PRIOR ART AND OBJECTIVES OF THE INVENTION

Camping has become more popular over the last few years with RV ownership significantly increasing due to the cost increases of vacationing rentals, increases in vacationing activities, potential health threats and more. Most campgrounds, especially the increased number of new campgrounds, provide a sewer or septic pipe connection attached to a waste disposal system for each campsite. When the RV is attached to a waste disposal drain, the RV holding tank can be emptied at any time, with the sewage being collected and processed by a waste processing system.

The waste disposal drain pipe at a campsite may vary in distance, height and angle from campsite to campsite, and be surrounded by a variety of terrain obstacles. The terrain obstacles can include uneven terrain, rocks, trees, curbs, posts and countless other obstacles. Since gravity drains require a constant downward slope, any sags in the hose or other uneven obstacles can hinder the intended use of the flexible sewer hose. While the market currently offers a variety of different types of trays, cradles, trestles, stakes, sectional supports, legs and other similar items, they fall short of the task of continuous hose support and required downward angle. They follow the uneven terrain, are limited by obstacles or have gaps in the support making it almost impossible to maintain drainage flow. The current market hose supports allow the flexible sewer hose to sag, pinch, have incorrect slopes, misalignment or roll, limiting or stopping the required downward gravity angle for proper discharge. These products are also cumbersome to work with, come in several pieces and require the RV owner to constantly adjustment the pieces, and most of the time fall short of the goal. The high majority of RV owners would like this to improved.

The main objectives of the invention are to:
Control the straightness and angle of the of the RV flexible sewer hose to provide the best possible downward flow between two points; the RV holding tank or drain connector and the septic or sewer waste disposal pipe or pipe adapter.
Provide complete rigid control, from connection to connection, not allowing the flexible sewer hose be unsupported, sag or roll.
Adapt to a variety of distance, heights and angles at the connection points.
Be universally designed to work with most RV flexible sewer hoses and clamps on the market.
Be easily setup or taken down.
Easily rinse out for storage.
Be easily stowed away.
Save time during setup, teardown and storage.
Be durable and unaffected by debris and weather conditions.
Significantly reduce the hassle and cumbersome handling of the multi-piece RV sewer hose and support.
Improve the most unsanitary and disliked part of the camping process, almost making it satisfying.

### 4. SUMMARY OF THE INVENTION

The aforementioned and other objectives are realized by providing a sewer hose support which compliments most of the RV flexible sewer hoses and clamps on the market. When combined with an RV flexible sewer hose and clamps, this support can be an all-in-one solution for the RV waste drainage and self-contained storage solution. The sewer hose support is molded and extruded of a lightweight and durable plastic, with the tube end components glued or ultrasonically welded to the tubes. The support includes a swivel and pivoting head at each end for controlling the angle of attachment. These swivel and pivoting actions are for containment and rigid handling of the flexible sewer hose bends, yet highly movable as not to bind or hinder the intended performance of the flexible sewer hose. The length is controlled by a succession of telescoping tubes for collapsing and expanding the sewer hose support to reach the waste disposal connection, generally at a campsite or a holding tank dump-station. Couplers can be tightened at the point that each tube enters the larger tube in the telescoping process for a strengthened joining connection.

For setup, the RV owner would remove the leading end RV flexible sewer hose cap from the hose connector and manually attach it to the RV holding tank or drain connector. The RV owner would then manually extend the tubes equally, remove the RV flexible sewer hose's trailing cap from the hose connector and attach the hose connector to the septic or sewer waste disposal pipe or pipe adapter.

For teardown, the RV owner would manually disconnect the leading end of the RV flexible sewer hose connection from the RV holding tank or drain connector, and retract or collapse the tubes the shortest position. The RV owner would then place the RV flexible sewer hose leading cap into the hose connector. Finally, the RV owner would disconnect the RV flexible sewer hose's trailing connector from the septic or sewer waste disposal pipe or pipe adapter; and place the RV flexible sewer hose's trailing cap onto the hose's connector.

When rinsing the flexible sewer hose prior to storage, as most RV owners do, the RV owner can leave the trailing end attached to the septic or sewer waste disposal pipe or pipe adapter, manually disconnect the leading end from the RV holding tank or drain connector, and rinse it out with a hose or other method. The rigid support of the sewer hose support tubes permits for a better rinse because it keeps the hose straight and allows the RV owner to elevate the hose for better drainage. Without this invention, the hose sags on the ground, fill with water and is very hard to control. Also, the RV owner would only be able to hold the hose as high as they can reach for limited drainage. The pertained invention allows the RV owner to leave the tubes fully extended for better drainage because the leading end could go much higher and the hose would not be able to sag and trap water at the bottom like current market products.

When not in use, the RV owner can retract or compress the telescoping tubes and place the flexible sewer hose caps on each end for a self-contained storage solution. This provides an all-in-one solution that can be easily stored in the RV's storage compartment. Existing market products require multiple pieces to be stored and handled as a cumbersome collection of puzzle pieces to assemble and dis-assemble.

### 5. BRIEF DESCRIPTION OF THE DRAWINGS

FIG. 1 shows the invention in a semi-closed position.

FIG. 2 shows the invention from FIG. 1 integrated with a RV flexible sewer hose and two hose clamps.

FIG. 3 illustrates an enlarged view of the leading end A of the sewer hose support from FIG. 2 in a stored position.

FIG. 4 features an enlarged cross-sectional view of the leading end A as seen along lines 4-4 of FIG. 3.

FIG. 5 pictures an enlarged view of the capable bi-directional pivot and 360° swivel motions of the leading end A sewer hose support, seen in FIG. 3; these also reflect the identical motions for the trailing end D as seen in FIG. 2.

FIG. 6 illustrates an enlarged view of the first tube coupler B, of the sewer hose support from FIG. 2 in a semi-open position.

FIG. 7 features an enlarged cross-sectional view from FIG. 6, of the first tube coupler B, as seen along lines 7-7; this view also reflects the identical operation of the second tube coupler C as seen in FIG. 2.

FIG. 8 illustrates an enlarged view of the second tube coupler C of the sewer hose support from FIG. 2 in a semi-open position.

FIG. 9 illustrates an enlarged view of the trailing end D of the sewer hose support from FIG. 2 in a storage position.

FIG. 10 pictures an in-use perspective view of the sewer hose support with an RV flexible sewer hose kit and two hose clamps, secured to a recreational vehicle.

FIG. 11 pictures a perspective view of the sewer hose support in a several of its lengths and angle of connection positions.

### 6. DETAILED DESCRIPTION OF THE PREFERRED EMBODIMENTS AND OPERATION OF THE INVENTION

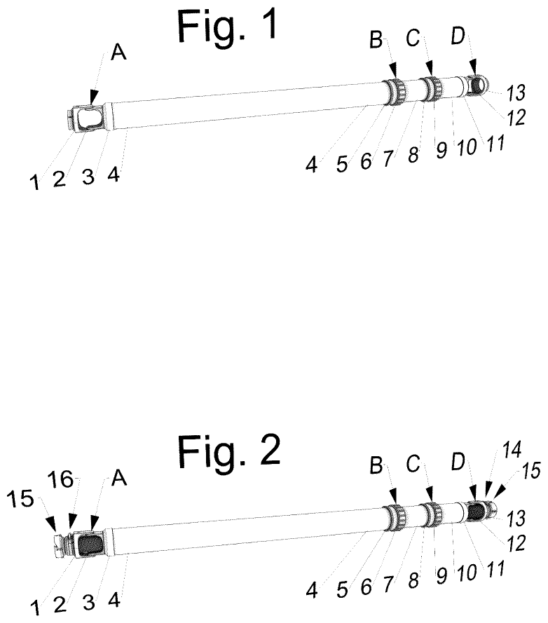

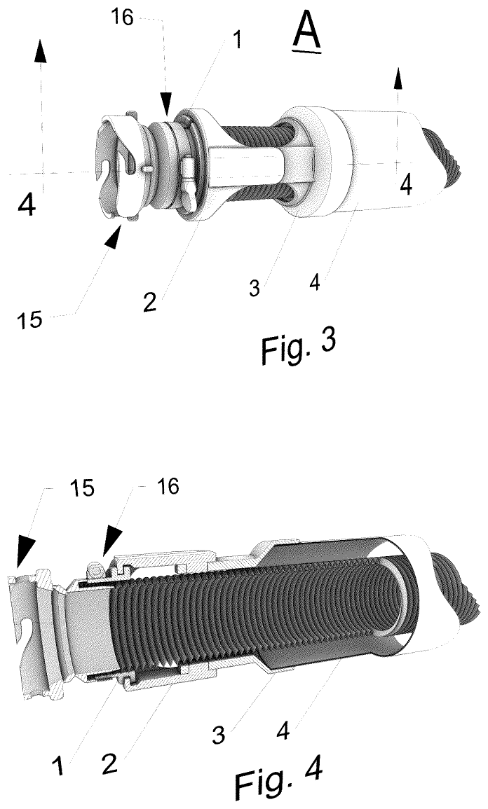

To better understand the invention and its use, the drawings and this outline will provide some clarification. This sewer hose support was designed with the flexibility to work with most of the RV flexible sewer hose and hose clamps available on the market for an all-in-one drainage solution. The sewer hose support pictured in FIG. 1, shows the invention without the market available RV flexible sewer hose 15 and hose clamps 14 and 16 shown in FIG. 2. The sewer hose support pictured in FIG. 2 displays the invention combined with the market available RV flexible sewer hose 15 and hose clamps 14 and 16. An enlarged view of the sewer hose support's leading end A in FIG. 3, taken from in FIG. 2, shows the end that would be connected to the RV holding tank connection 17 in FIG. 10. The leading end A assembly in FIG. 3 and FIG. 4 is comprised of the swivel mechanism 1 that rotates at the pivot head 2. This allows the market available RV Flexible sewer hose 15 to be tightened onto the RV holding tank connection without influencing the remainder of the sewer hose support. The pivot head 2 is allowed to pivot through radial attachments on the tube pivot 3 which is connected to the first tube 4. When combining the swivel and pivot together, the connection end assembly is able to match nearly any connecting angle that a campsite may require.

The leading end A cut-away in FIG. 4 shows the cross-section as identified with 4-4 on FIG. 3. The connection end pivot and swivel motion capabilities shown in FIG. 5 are both the leading end A and trailing end D of the sewer hose support shown in FIG. 2, though only the leading end A is pictured.

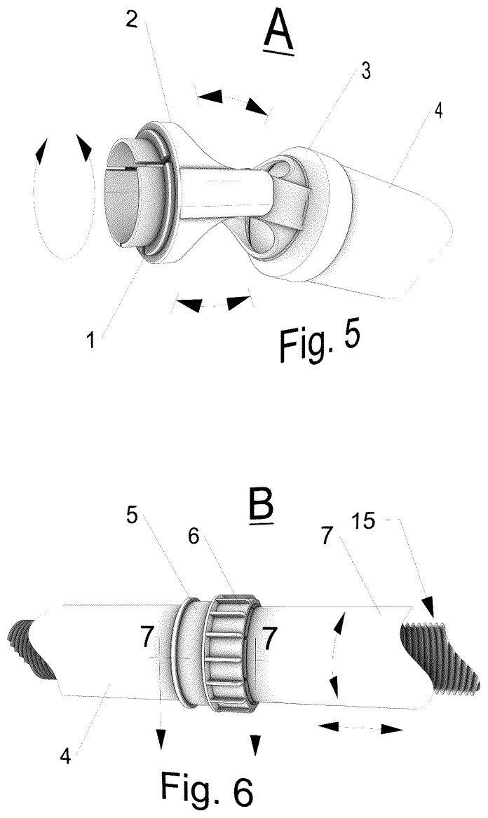

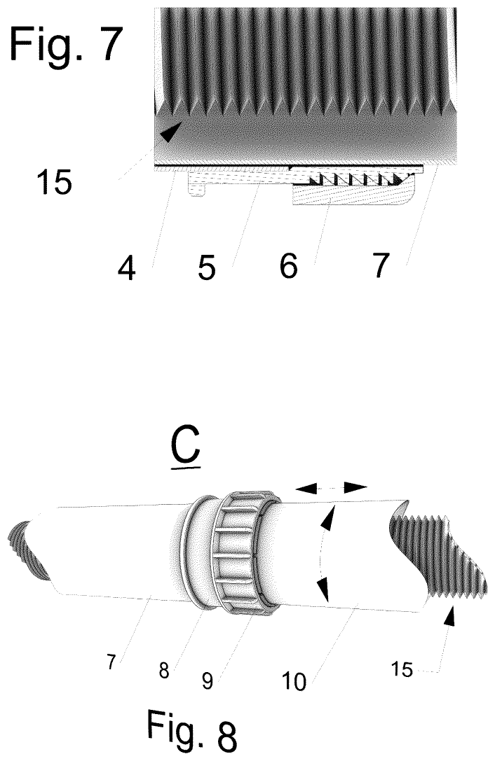

An enlarged view in FIG. 6 of the first tube coupler B taken from FIG. 2, shows the second tube 7, and how it travels parallel and rotates radially within the first tube 4 and the coupler B assembly. Components 5 and 6 together make up the coupler B assembly. The FIG. 7 coupler B cut-away shows the cross-section as identified with 7-7 on FIG. 6. Both coupler B and coupler C of the sewer hose support shown in FIG. 2, have these parallel travel and rotate capabilities, though only coupler B is pictured.

An enlarged view in FIG. 8 of the second tube coupler C taken from FIG. 2, shows the third tube 10, and its capabilities to travels parallel and rotate radially within the second tube 7 and coupler C assembly. Components 8 and 9 together make up the assembly of coupler C.

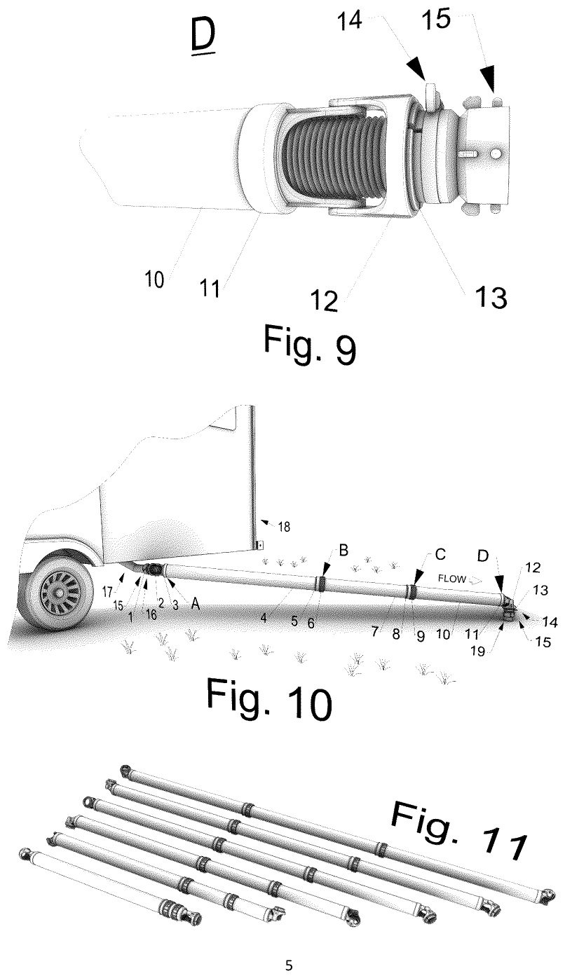

An enlarged view of the sewer hose support's trailing end D in FIG. 9, taken from FIG. 2, shows the end that would be connected to the waste disposal connection 19 in FIG. 10. The trailing end D assembly in FIG. 9 is comprised of the swivel mechanism 13 that rotates at the pivot head 12. This allows the market available RV flexible sewer hose 15 to be tightened into the waste disposal connection without binding. The pivot head 12 is allowed to pivot through radial attachments on the tube pivot 11 which is connected to the third tube 10. When combining the swivel and pivot together, the connection end assembly is able to match almost any connecting waste disposal inlet pipe angle that a campsite may require.

The in-use perspective view of the sewer hose support in FIG. 10, that is displayed with a market purchased RV flexible sewer hose and two hose clamps in FIG. 2, will illuminate the intended use of the RV sewer hose support. Generally, the holding tank connection 17 can be located along the left-hand side of the recreational vehicle 18 as seen in FIG. 10. The RV sewer hose support, as seen in FIG. 2, connects to the RV holding tank connection 17 at the leading end A and connects to the waste disposal connection 19 on the trailing end D of the support. The flow direction outlined in FIG. 10 indicates the direction that the waste will travel gravitationally to the waste disposal connection. The perspective view in FIG. 11 displays the sewer hose support in various lengths and connection end angles, starting with the stored position (shortest) on the lower left view of FIG. 11. The sewer hose supports shown in FIG. 11 only shows several positions of fluid positioning of the invention. The illustrations and examples provided herein are for explanatory purposes and are not intended to limit the scope of the appended claims. The scope may include, but not limited to; added or reduced number of couplers, added or reduced tube lengths, ball and socket type bend support, other variants that mimic the actions of the sewer hose support as described herein. Finally, the outlined sewer hose support connected to a shorter or longer variant of the invention, may be connected together to traverse obstacles that a single sewer hose support may not be able to achieve.

We claim:

1) A sewer hose support comprising of: a mechanism at each end for controlling the angle of attachment that each have swivel and pivoting actions for containment and rigid handling of the RV flexible sewer hose's required bend points; a middle area of telescoping tubes for collapsing and expanding to reach the waste disposal connection, or for storage when not in use; and couplers that can tighten at the point that each tube enters the larger tube in the telescoping process for a strengthened connection.

2) The support of claim 1 in which said sewer hose support is to be made of formed and extruded durable plastic.

3) The support of claim 1 in which said tubes in succession are slightly smaller in diameter to insert into the preceding tube and perform the telescoping function.

4) The support of claim 1 in which is intended to compliment most market available RV flexible sewer hoses.

5) The support of claim 1 in which said support will bias the sewer hose flow at a downward angle when said support is attached properly.

6) The sewer hose support, when including a flexible sewer hose and two hose clamps, will be a self-contained, all-in-one drainage solution.

7) The sewer hose support, when collapsed, will store effortlessly in the RV storage compartment.

8) The sewer hose support, is simple enough in design that, when combined with a flexible sewer hose and two hose clamps, can be used by an untrained RV owner.
